(19) United States
(12) Patent Application Publication
(10) Pub. No.: US 2014/0220818 A1
(43) Pub. Date: Aug. 7, 2014

(54) RECETACLE ADAPTOR SUPPORT PLATE

(71) Applicant: Rene Gomez, Southwest Ranches, FL (US)

(72) Inventor: Rene Gomez, Southwest Ranches, FL (US)

(21) Appl. No.: 14/174,586

(22) Filed: Feb. 6, 2014

Related U.S. Application Data
(60) Provisional application No. 61/761,585, filed on Feb. 6, 2013.

(51) Int. Cl. H01R 31/06; H01R 43/26

(52) U.S. Cl. CPC H01R 31/06; H01R 43/26
USPC 439/573; 29/876

(57) ABSTRACT

An adaptor that fits over an electrical receptacle. The adaptor may include a plate member. The plate member may include slots running through that align with electrical sockets on an electrical receptacle. The adaptor may be attached to the electrical receptacle via screws. The plate member may further include a threaded hub. Therefore, a plug-in transformer may plug into an electrical receptacle through the adaptor and may be screwed into the adapter for further securement.

### CROSS-REFERENCE TO RELATED APPLICATION

This application claims the benefit of priority of U.S. provisional application No. 61/761,585, filed Feb. 6, 2013, the contents of which are herein incorporated by reference.

### BACKGROUND OF THE INVENTION

The present invention relates to an adapter and, more particularly, to an adapter for securing a plug-transformer to an electrical receptacle.

Decora® style receptacles are commonly used in businesses and at home. Currently, Decora® style receptacles fail to provide a means of securely fastening a plug-in transformer to the receptacle. Therefore, an electrician must be hired to replace the receptacle, which adds cost.

As can be seen, there is a need for an adaptor used to secure a plug-in transformer to an electrical receptacle.

### SUMMARY OF THE INVENTION

In one aspect of the present invention, a receptacle adaptor comprises: a plate member comprising at least a first pair of slots configured to align with upper electrical sockets, at least a second pair of slots configured to align with lower electrical sockets, a first mounting screw hole formed through the plate member and above the first set of slots, a second mounting screw hole formed through the plate member and below the second set of slots, and a threaded hub in between the first set of slots, and the second set of slots.

In another aspect of the present invention, a receptacle adaptor comprises: a plate member comprising a front surface and a rear surface, wherein the plate member comprises at least a first pair of slots running through the front surface and rear surface and configured to align with electrical sockets, wherein the plate member comprises an attachment component configured to attach to an electrical receptacle; and a threaded hub mounted in the front surface of the plate member.

In another aspect of the present invention, a method of mounting a plug-in transformer adaptor to an electrical receptacle comprises: providing an adaptor comprising a plate comprising at least a first pair of slots and at least a second pair of slots, and a first mounting screw hole formed above the first pair of slots, a second mounting screw hole formed below the second pair of slots, and a threaded hub member in between the first pair of slots and the second pair slots; and attaching the adapter to the electrical receptacle by driving mounting screws through the first mounting screw hole and the second mounting screw hole, thereby securing the adapter over the electrical receptacle.

These and other features, aspects and advantages of the present invention will become better understood with reference to the following drawings, description and claims.

### BRIEF DESCRIPTION OF THE DRAWINGS

FIG. 1 is a perspective view of the present invention shown in use;

FIG. 2 is an exploded view of the present invention shown in use;

FIG. 3 is a front perspective view of the present invention;

FIG. 4 is a rear perspective view of the present invention; and

FIG. 5 is an exploded view of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a Decora® receptacle adaptor support plate that provides the support mechanism for plug-in transformers and alike. The Decora® Receptacle Adaptor Support Plate provides a threaded hub insert in the center of the plate to accommodate the screw from the transformer, thus providing a secure fastened transformer onto the plate. By just removing the Decora® trim plate from the receptacle and installing the Decora® Receptacle Adaptor Support plate, no electrical wiring needs to be tampered with reducing liability, time, and money.

A plastic rectangular shaped plate approximately 4.5 in×2.75 inches may include about a 0.125 inch threaded hub fused into the center of the plate. There may be a raised portion in the center of the plate to accommodate the existing receptacle. The plate may include two screw holes with one on top and one on bottom of the plate to accommodate the screws to attach the plate onto the receptacle. Simply remove the existing trim plate from a standard Decora® receptacle by unscrewing the top and bottom screws. Then install the Decora® Receptacle Adaptor Support Plate over the existing Decora® receptacle and fasten the plate by using the top and bottom 6:32 screws from the previous plate. The plug-in transformer or the like may be plugged in the receptacle and securely fastened to the adapter by using the 6:32×0.0125 machine screw.

Broadly, an embodiment of the present invention provides an adaptor that fits over an electrical receptacle. The adaptor may include a plate member. The plate member may include slots running through that align with electrical sockets on an electrical receptacle. The adaptor may be attached to the electrical receptacle via screws. The plate member may further include a threaded hub. Therefore, a plug-in transformer may plug into an electrical receptacle through the adaptor and may be screwed into the adapter for further securement.

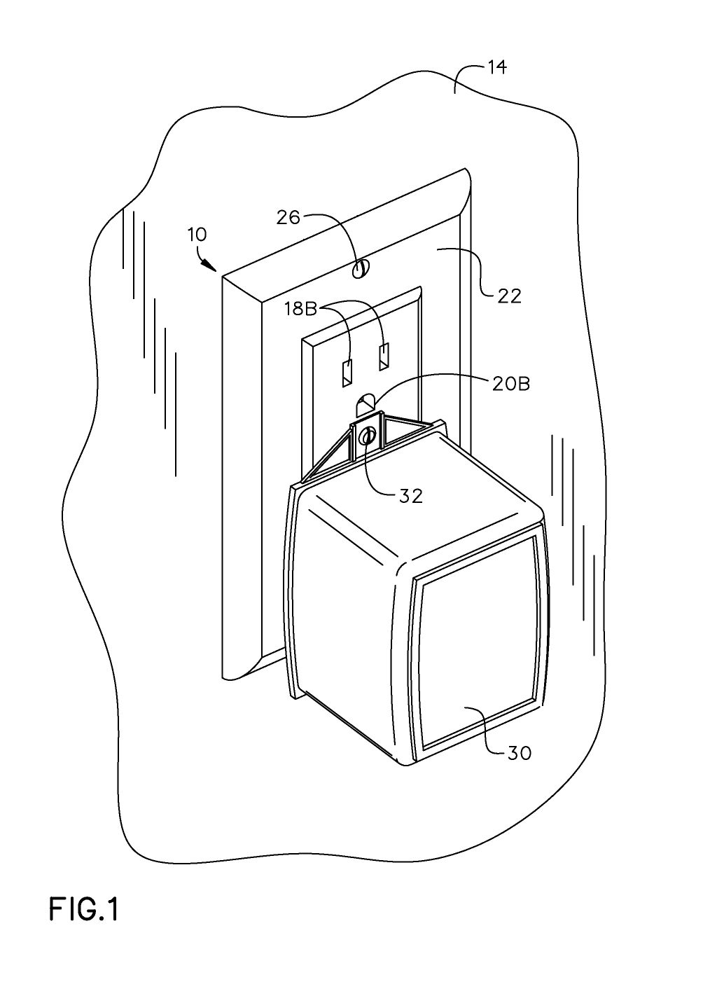

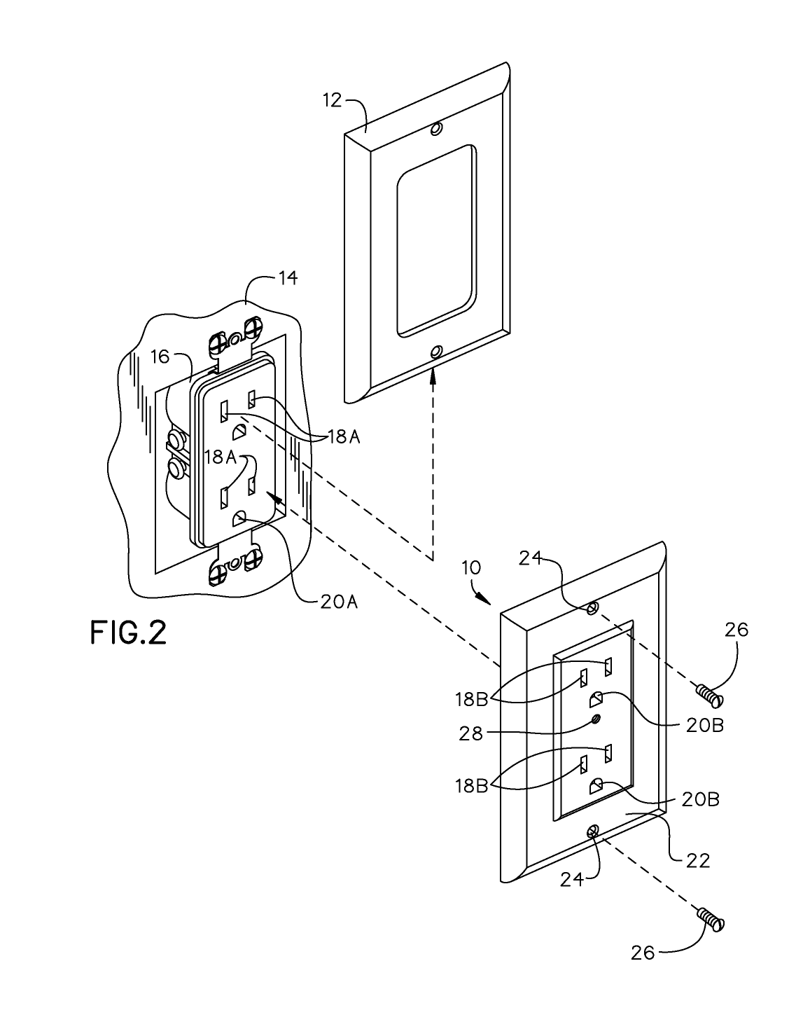

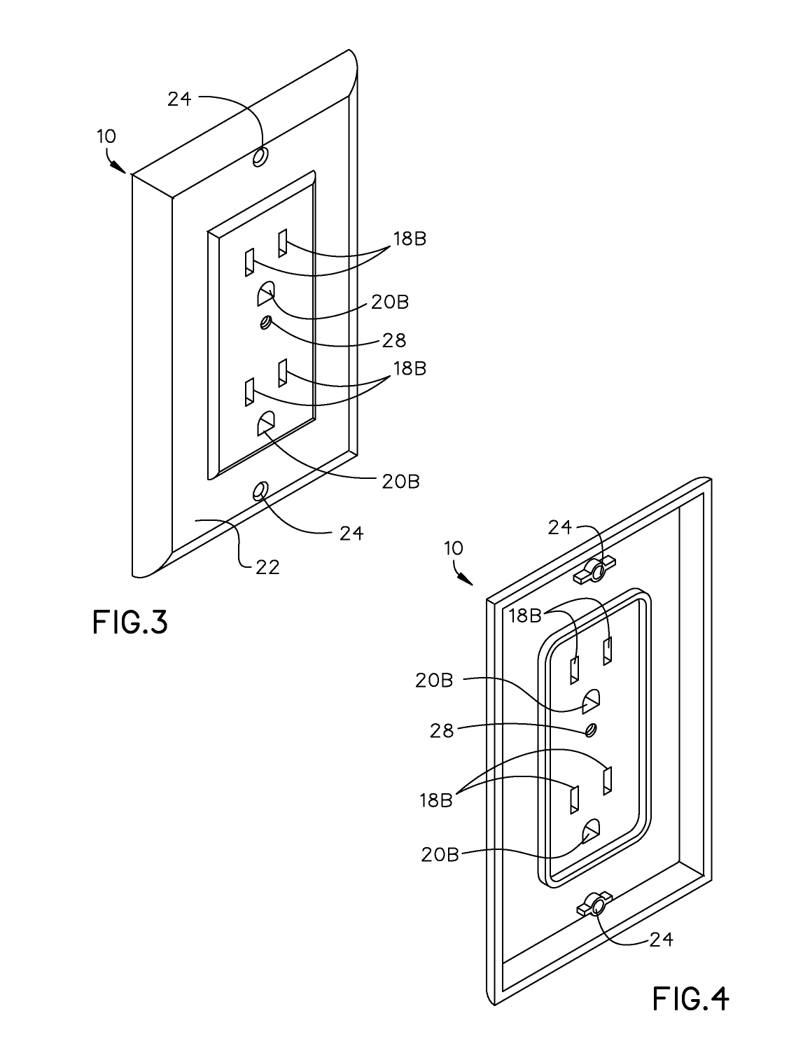

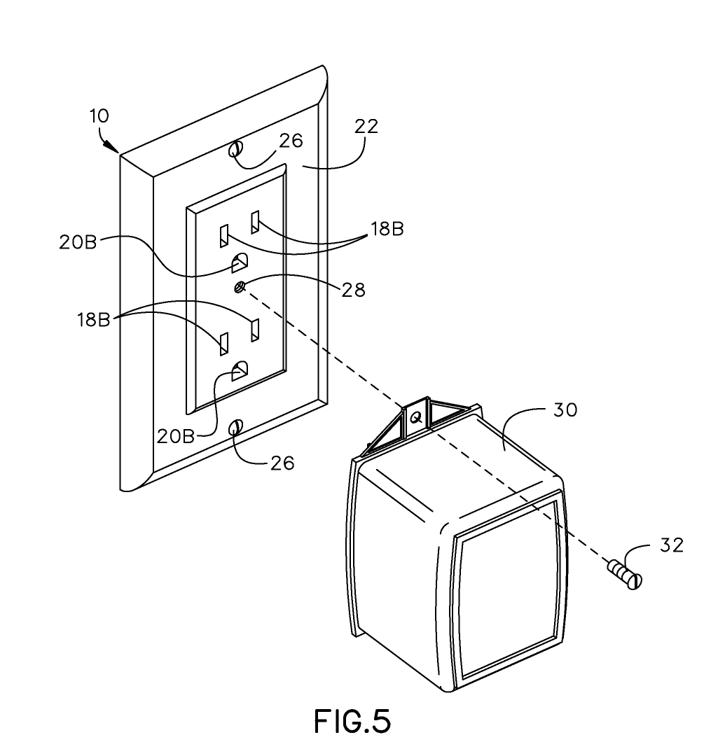

Referring to FIGS. 1 through 5, the present invention includes a receptacle adaptor 10. The receptacle adaptor 10 includes a plate member 22 having a front surface and a rear surface. The plate member 22 may include slots or openings that align with an electrical receptacle 16. For example, the plate member 22 may include a first pair of slots 18B and a second pair of slots 18B. Further, in certain embodiments, a first ground slot 20B is formed below the first pair of slots 18B, and a second ground slot 20B is formed below the second pair of slots 18B.

The receptacle adaptor 10 may be attached to fit over the electrical receptacle 16 by an attachment component. The attachment component may include a first mounting screw hole 24 above the first pair of slots 18B and a second mounting screw hole 24 below the second pair of slots 18B. The attachment component may further include mounting screws 26 that may run through the first and second mounting screw holes 24 and into a threaded receiving slot in the electrical receptacle 16 or into the wall 14 to secure the receptacle adaptor 10 over the electrical receptacle 16. When the receptacle adaptor 10 is attached to the electrical receptacle 16, the first pair of slots 18B may align with upper electrical sockets 18A and the second pair of slots 18B may align with lower electrical sockets 18B. Further, the first ground slot 20B may align with an upper ground electrical socket 20A and the second ground slot 20B may align with a lower ground electrical socket 20A.

The present invention may further include a threaded hub 28 running through the front surface of the plate member 10. In certain embodiments, the threaded hub 28 may not protrude through the rear surface. In certain embodiments, the threaded hub 28 may be an infused metal hub. Using the threaded hub 28, a plug-in transformer 30 may be plugged into the lower electrical sockets 18A through the second pair of slots 18B. A plug-in transformer screw 32 may be driven through a slot in the plug-in transformer 30 and into the threaded hub 28, thereby securing the plug-in transformer 30 to the receptacle adaptor 10.

A method of mounting a plug-in transformer adaptor 30 to an electrical receptacle 16 may include the following: providing an adaptor 10 including a plate 22 having at least a first pair of slots 18B and at least a second pair of slots 18B, and a first mounting screw hole 24 formed above the first pair of slots 18B, a second mounting screw hole 24 formed below the second pair of slots 18B, and a threaded hub member 28 in between the first pair of slots 18B and the second pair slots 18B; and attaching the adapter 10 to the electrical receptacle 16 by driving mounting screws 26 through the first mounting screw hole 24 and the second mounting screw hole 24, thereby securing the adapter 10 over the electrical receptacle 16. The method may further include the steps of removing a standard plate 12 from the electrical receptacle 16 prior to attaching the adapter 10 to the electrical receptacle 16; plugging in a plug-in transformer 30 through at least one of the first pair of slots 18B and the second pair of slots 18B; and driving a screw 32 through a slot opening in the plug-in transformer 30 and into threaded hub member 28, thereby securing the plug-in transformer 30 to the adaptor 10.

It should be understood, of course, that the foregoing relates to exemplary embodiments of the invention and that modifications may be made without departing from the spirit and scope of the invention as set forth in the following claims.

What is claimed is:

1. A receptacle adaptor comprising:
a plate member comprising at least a first pair of slots configured to align with upper electrical sockets, at least a second pair of slots configured to align with lower electrical sockets, a first mounting screw hole formed through the plate member and above the first set of slots, a second mounting screw hole formed through the plate member and below the second set of slots, and a threaded hub in between the first set of slots, and the second set of slots.

2. The receptacle adaptor of claim 1, wherein a first ground slot is formed below the first pair of slots, and a second ground slot is formed below the second pair of slots.

3. The receptacle adaptor of claim 1, further comprising a plug-in transformer plugged into the second pair of slots, wherein a screw is driven through a slot opening in the plug-in transformer and into the threaded hub.

4. A receptacle adaptor comprising:
a plate member comprising a front surface and a rear surface, wherein the plate member comprises at least a first pair of slots running through the front surface and rear surface and configured to align with electrical sockets, wherein the plate member comprises an attachment component configured to attach to an electrical receptacle; and
a threaded hub mounted in the front surface of the plate member.

5. The receptacle adaptor of claim 4, wherein the plate member further comprises a second pair of slots running through the front surface and rear surface and configured to align with electrical sockets.

6. The receptacle adaptor of claim 5, wherein the attachment component comprises a first mounting screw hole formed through the plate member and above the first pair of slots, a second mounting screw hole formed through the plate member and below the second pair of slots.

7. The receptacle adaptor of claim 5, wherein the threaded hub is mounted in between the first pair of slots and the second pair of slots.

8. The receptacle adaptor of claim 7, wherein a first ground slot is formed below the first pair of slots, and a second ground slot is formed below the second pair of slots.

9. A method of mounting a plug-in transformer adaptor to an electrical receptacle comprising:
providing an adaptor comprising a plate comprising at least a first pair of slots and at least a second pair of slots, and a first mounting screw hole formed above the first pair of slots, a second mounting screw hole formed below the second pair of slots, and a threaded hub member in between the first pair of slots and the second pair slots; and
attaching the adapter to the electrical receptacle by driving mounting screws through the first mounting screw hole and the second mounting screw hole, thereby securing the adapter over the electrical receptacle.

10. The method of claim 9, further comprising the step of removing a standard plate from the electrical receptacle prior to attaching the adapter to the electrical receptacle.

11. The method of claim 9, wherein a first ground slot is formed below the first pair of slots, and a second ground slot is formed below the second pair of slots.

12. The method of claim 9, further comprising plugging in a plug-in transformer through at least one of the first pair of slots and the second pair of slots.

13. The method of claim 12, further comprising the step of driving a screw through a slot opening in the plug-in transformer and into threaded hub member, thereby securing the plug-in transformer to the adaptor.
